(19) United States
(12) Patent Application Publication
(10) Pub. No.: US 2026/0133823 A1
(43) Pub. Date: May 14, 2026

(54) TASK ARBITRATION

(71) Applicant: Google LLC, Mountain View, CA (US)

(72) Inventors: Matthew Sharifi, Kilchberg (CH); Victor Carbune, Zürich (CH)

(73) Assignee: Google LLC, Mountain View, CA (US)

(21) Appl. No.: 18/945,502

(22) Filed: Nov. 12, 2024

(51) Int. Cl. G06F 9/48; G06F 16/33

(52) U.S. Cl. CPC G06F 9/4881; G06F 16/3344

(57) ABSTRACT

A method includes receiving a query specifying a task to be performed and executing an arbitration process for selecting an LLM-based assistant to fulfill performance of the task specified by the query. The method also includes soliciting each corresponding other LLM-based assistant in the subset of the LLM-based assistants that was not selected to fulfill performance of the task to provide a respective collaboration input indicating how the corresponding other LLM-based assistant would respond to the query. The method also includes generating a final answer to the query that fulfills performance of the task specified by the query based on the respective collaboration input provided by each corresponding other LLM-based assistant in the subset of LLM-based assistants.

### TECHNICAL FIELD

This disclosure relates to task arbitration.

### BACKGROUND

In recent years, the field of artificial intelligence (AI) has seen significant advancements, particularly in the development and deployment of large language models (LLMs). These models are used in various domains, including natural language processing, machine translation, and automated content creation. As the capabilities of LLMs have expanded, so too has the complexity of tasks they are expected to perform. This has led to the emergence of scenarios where multiple LLMs are employed simultaneously to handle diverse and intricate tasks. However, the coordination and efficient utilization of these models present unique challenges, such as selecting which of the multiple LLMs should process each task. Moreover, the dynamic nature of task requirements necessitates adaptive strategies for task allocation and resource management among the LLMs.

### SUMMARY

One aspect of the disclosure provides a computer-implemented method executing on data processing hardware that causes the data processing hardware to perform operations for task arbitration. The operations include receiving a query specifying a task to be performed and executing an arbitration process for selecting an LLM-based assistant to fulfill performance of the task specified by the user from a set of available large language model (LLM)-based assistants. The arbitration process includes, at each corresponding LLM-based assistant in the set of available LLM-based assistants: processing the query to determine whether the corresponding LLM-based assistant self-identifies as being capable of fulfilling performance of the task specified by the query; and providing to each other LLM-based assistant in the set of available LLM-based assistants, a corresponding volunteer bid from the corresponding LLM-based assistant that offers to fulfill performance of the task on-behalf of the other LLM-based assistants in the set of available LLM-based assistants over an arbitration communication channel when the corresponding LLM-based assistant self-identifies as being capable of fulfilling performance of the task. The arbitration process also includes selecting the LLM-based assistant to fulfill performance of the task specified by the query from a subset of LLM-based assistants that include each of the LLM-based assistants in the set of available LLM-based assistants that provided corresponding volunteer bids over the communication channel. The method also includes generating a final answer to the query that fulfills performance of the task specified by the query by the selected LLM-based assistant based on the respective collaboration input provided by each corresponding other LLM-based assistant in the subset of LLM-based assistants.

Implementations of the disclosure may include one or more of the following optional features. In some implementations, receiving the query includes receiving the query at each LLM-based assistant in the set of available LLM-based assistants and execution of the arbitration process for selecting the LLM-based assistant to fulfill performance of the task is initiated by one or more of the LLM-based assistants in the set of available LLM-based assistants. In these implementations, the query received at each LLM-based assistant in the set of available LLM-based assistants may be received over a query communication channel that is different than the arbitration communication channel.

In some examples, providing the corresponding volunteer bid from the corresponding LLM-based assistant further includes providing a corresponding justification that provides an explanation for why the corresponding LLM-based assistant self-identifies as being capable of fulfilling performance of the task specified by the query over the arbitration communication channel to each other LLM-based assistant in the set of available LLM-based assistants. Selecting the LLM-based assistant to fulfill performance of the task specified by the query may include: at each corresponding LLM-based assistant in the subset of LLM-based assistants, processing the corresponding volunteer bids and the corresponding justifications provided by the other LLM-based assistants in the subset of LLM-based assistants to identify a best LLM-based assistant in the subset of LLM-based assistants to fulfill performance of the task and providing a corresponding vote to select the LLM-based assistant to fulfill performance of the task over the arbitration communication channel to each other LLM-based assistant in the subset of LLM-based assistants. Here, after selecting the candidate LLM-based assistant to fulfill performance of the task, the operations may further include executing one or more rebuttal rounds of the arbitration process and, after execution of the one or more rebuttal rounds is complete, determining which LLM-based assistant in the subset of LLM-based assistants includes a greatest number of votes to fulfill performance of the task. Each rebuttal round includes, at each corresponding LLM-based assistant in the subset of LLM-based assistants, providing a corresponding chain-of-thought (CoT) reasoning for why the corresponding LLM-based assistant provided the corresponding vote to select the LLM-based assistant that the corresponding LLM-based assistant identified as the best LLM-based assistant to fulfill performance of the task over the arbitration communication channel to each other LLM-based assistant in the subset of LLM-based assistants, processing the corresponding CoT reasonings provided from the other LLM-based assistants in the subset of LLM-based assistants to determine whether the corresponding LLM-based assistant should update the corresponding vote to select a different one of the LLM-based assistants to fulfill performance of the task, and providing a corresponding updated vote to select the different one of the LLM-based assistants that the corresponding LLM-based assistant identified as the best LLM-based assistant to fulfill performance of the task over the arbitration communication channel to each other LLM-based assistant in the subset of LLM-based assistants when the corresponding LLM-based assistant determines to update the corresponding vote to select the different one of the LLM-based assistants. Here, selecting the LLM-based assistant to fulfill performance of the task specified by the query includes selecting, from the subset of LLM-based assistants, the LLM-based assistant determined to include the greatest number of votes to fulfill performance of the task. In these examples, the corresponding justification provides the explanation as natural language text.

In some implementations, the arbitration process further includes determining which LLM-based assistant in the subset of LLM-based assistants was first to provide the corresponding volunteer bid over the communication channel. In these implementations, selecting the LLM-based assistant to fulfill performance of the task specified by the query includes selecting the LLM-based assistant to fulfill performance of the task as the LLM-based assistant in the subset of LLM-based assistants that was first to provide the corresponding volunteer bid over the communication channel. In some examples, the operations further include, soliciting, by the selected LLM-based assistant, each corresponding other LLM-based assistant in the subset of the LLM-based assistants that was not selected to fulfill performance of the task to provide a respective contextual cue indicating guidance for the selected LLM-based assistant to consider when generating the final answer to the query. Here, generating the final answer to the query is further based on the respective contextual cue provided by each corresponding other LLM-based assistant in the subset of LLM-based assistants. Each corresponding LLM-based assistant in the set of available LLM-based assistants is conditioned to perform a respective type of task that is different than each other LLM-based assistant in the set of available LLM-based assistants.

Another aspect of the disclosure provides a system that includes data processing hardware and memory hardware storing instructions that when executed on the data processing hardware causes the data processing hardware to perform operations. The operations include receiving a query specifying a task to be performed and executing an arbitration process for selecting an LLM-based assistant to fulfill performance of the task specified by the user from a set of available large language model (LLM)-based assistants. The arbitration process includes, at each corresponding LLM-based assistant in the set of available LLM-based assistants: processing the query to determine whether the corresponding LLM-based assistant self-identifies as being capable of fulfilling performance of the task specified by the query; and providing to each other LLM-based assistant in the set of available LLM-based assistants, a corresponding volunteer bid from the corresponding LLM-based assistant that offers to fulfill performance of the task on-behalf of the other LLM-based assistants in the set of available LLM-based assistants over an arbitration communication channel when the corresponding LLM-based assistant self-identifies as being capable of fulfilling performance of the task. The arbitration process also includes selecting the LLM-based assistant to fulfill performance of the task specified by the query from a subset of LLM-based assistants that include each of the LLM-based assistants in the set of available LLM-based assistants that provided corresponding volunteer bids over the communication channel. The method also includes generating a final answer to the query that fulfills performance of the task specified by the query by the selected LLM-based assistant based on the respective collaboration input provided by each corresponding other LLM-based assistant in the subset of LLM-based assistants.

Implementations of the disclosure may include one or more of the following optional features. In some implementations, receiving the query includes receiving the query at each LLM-based assistant in the set of available LLM-based assistants and execution of the arbitration process for selecting the LLM-based assistant to fulfill performance of the task is initiated by one or more of the LLM-based assistants in the set of available LLM-based assistants. In these implementations, the query received at each LLM-based assistant in the set of available LLM-based assistants may be received over a query communication channel that is different than the arbitration communication channel.

In some examples, providing the corresponding volunteer bid from the corresponding LLM-based assistant further includes providing a corresponding justification that provides an explanation for why the corresponding LLM-based assistant self-identifies as being capable of fulfilling performance of the task specified by the query over the arbitration communication channel to each other LLM-based assistant in the set of available LLM-based assistants. Selecting the LLM-based assistant to fulfill performance of the task specified by the query may include: at each corresponding LLM-based assistant in the subset of LLM-based assistants, processing the corresponding volunteer bids and the corresponding justifications provided by the other LLM-based assistants in the subset of LLM-based assistants to identify a best LLM-based assistant in the subset of LLM-based assistants to fulfill performance of the task and providing a corresponding vote to select the LLM-based assistant to fulfill performance of the task over the arbitration communication channel to each other LLM-based assistant in the subset of LLM-based assistants. Here, after selecting the candidate LLM-based assistant to fulfill performance of the task, the operations may further include executing one or more rebuttal rounds of the arbitration process and, after execution of the one or more rebuttal rounds is complete, determining which LLM-based assistant in the subset of LLM-based assistants includes a greatest number of votes to fulfill performance of the task. Each rebuttal round includes, at each corresponding LLM-based assistant in the subset of LLM-based assistants, providing a corresponding chain-of-thought (CoT) reasoning for why the corresponding LLM-based assistant provided the corresponding vote to select the LLM-based assistant that the corresponding LLM-based assistant identified as the best LLM-based assistant to fulfill performance of the task over the arbitration communication channel to each other LLM-based assistant in the subset of LLM-based assistants, processing the corresponding CoT reasonings provided from the other LLM-based assistants in the subset of LLM-based assistants to determine whether the corresponding LLM-based assistant should update the corresponding vote to select a different one of the LLM-based assistants to fulfill performance of the task, and providing a corresponding updated vote to select the different one of the LLM-based assistants that the corresponding LLM-based assistant identified as the best LLM-based assistant to fulfill performance of the task over the arbitration communication channel to each other LLM-based assistant in the subset of LLM-based assistants when the corresponding LLM-based assistant determines to update the corresponding vote to select the different one of the LLM-based assistants. Here, selecting the LLM-based assistant to fulfill performance of the task specified by the query includes selecting, from the subset of LLM-based assistants, the LLM-based assistant determined to include the greatest number of votes to fulfill performance of the task. In these examples, the corresponding justification provides the explanation as natural language text.

In some implementations, the arbitration process further includes determining which LLM-based assistant in the subset of LLM-based assistants was first to provide the corresponding volunteer bid over the communication channel. In these implementations, selecting the LLM-based assistant to fulfill performance of the task specified by the query includes selecting the LLM-based assistant to fulfill performance of the task as the LLM-based assistant in the subset of LLM-based assistants that was first to provide the corresponding volunteer bid over the communication channel. In some examples, the operations further include, soliciting, by the selected LLM-based assistant, each corresponding other LLM-based assistant in the subset of the LLM-based assistants that was not selected to fulfill performance of the task to provide a respective contextual cue indicating guidance for the selected LLM-based assistant to consider when generating the final answer to the query. Here, generating the final answer to the query is further based on the respective contextual cue provided by each corresponding other LLM-based assistant in the subset of LLM-based assistants. Each corresponding LLM-based assistant in the set of available LLM-based assistants is conditioned to perform a respective type of task that is different than each other LLM-based assistant in the set of available LLM-based assistants.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system of performing task arbitration.

FIGS. 2A and 2B are schematic views of example arbitration processes.

FIG. 3 is a flowchart of an example arrangement of operations for a computer-implemented method of performing task arbitration.

FIG. 4 is a schematic view of an example computing device that may be used to implement the systems and methods described herein.

Like reference symbols in the various drawings indicate like elements.

### DETAILED DESCRIPTION

The advent of large language models (LLMs) has revolutionized the landscape of artificial intelligence, demonstrating state-of-the-art performance across a diverse array of tasks. These models have enabled significant advancements for digital assistants, and their capabilities are expected to continue evolving at a rapid pace. Recently, LLMs have become tailored to specific domains or functions. For instance, businesses may deploy a dedicated digital assistant that acts as a sales agent capable of engaging with customers about their product lines. Moreover, various specialized agents could be employed to manage tasks ranging from marketing, technical support, and finance within a single organization.

Implementations herein are directed towards a task arbitration system that receives a query specifying a task to be performed. The task arbitration system executes an arbitration process for selecting an LLM-based assistant to fulfill performance of the task specified by the query from a set of available LLM-based assistants. The arbitration process includes, at each corresponding LLM-based assistant in the set of available LLM-based assistants, processing the query to determine whether the corresponding LLM-based assistant self-identifies as being capable of fulfilling performance of the task specified by the query and providing a corresponding volunteer bid from the corresponding LLM-based assistant that offers to fulfill performance of the task on-behalf of the other LLM-based assistants in the set of available LLM-based assistants over an arbitration communication channel to each other LLM-based assistant in the set of available LLM-based assistants when the corresponding LLM-based assistant self-identifies as being capable of fulfilling performance of the task. The arbitration process also includes selecting the LLM-based assistant to fulfill performance of the task specified by the query from a subset of LLM-based assistants that include each of the LLM-based assistants in the set of available LLM-based assistants that provided corresponding volunteer bids over the communication channel. The task arbitration system also solicits, using the selected LLM-based assistant, each corresponding other LLM-based assistant in the subset of the LLM-based assistants that was not selected to fulfill performance of the task to provide a respective collaboration input indicating how the corresponding other LLM-based assistant would respond to the query over the arbitration communication channel. The task arbitration system also generates, using the selected LLM-based assistant, a final answer to the query that fulfills performance of the task specified by the query based on the respective collaboration input provided by each corresponding other LLM-based assistant in the subset of LLM-based assistants.

Advantageously, the task arbitration system performs arbitration among the LLM-based assistants for received queries in a peer-to-peer manner where the LLM-based assistants collaboratively determine the best-suited LLM-based assistant to handle a given task. This approach has many advantages compared to using a single meta-assistant or router model which directs tasks to the appropriate specialized agent, such as more efficient utilization of computing resources and reduced latency. Thus, the task arbitration system not only enhances the efficiency and accuracy of task allocation but also leverages the collective intelligence of multiple agents, thereby optimizing the overall performance of the system.

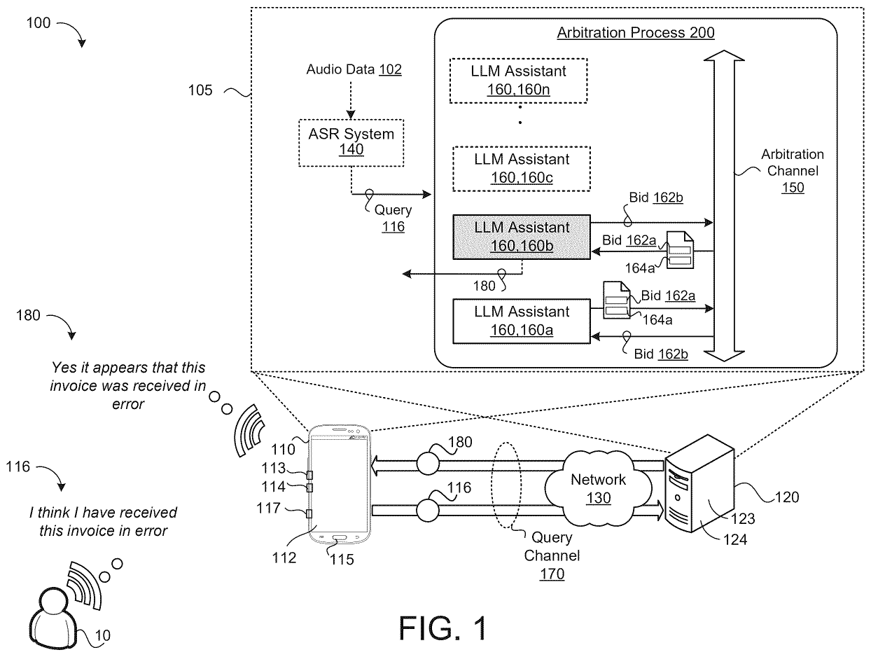

FIG. 1 illustrates an example system 100 including a task arbitration system 105 for allowing users 10 to interact with different LLM-based assistants 160 to perform action on behalf of the user 10. Generally, the user 10 inputs, via a user device 110, a natural language query 116 specifying a task to be performed on behalf of the user 10, and an arbitration process 200 selects one or more LLM-based assistants 160 from a set of available LLM-based assistants 160, 160a-n to fulfill performance of the task specified by the natural language query 116. Here, the set of LLM-based assistants 160 may process the natural language query 116 by performing query interpretation to ascertain the particular task to be performed. Fulfillment of the particular action may require performance of multiple portions, or sub-actions/tasks, that collectively define the particular action. As such, the arbitration process 200 may select each LLM-based assistant 160 to fulfill performance of a corresponding portion of the task specified by the natural language query 116. The arbitration process 200 may facilitate with or without involving input from the user 10, multiple interactions with the corresponding LLM-based assistant 160 until the corresponding portion of the task is fulfilled. As will become apparent, the selected LLM-based assistant generates a final answer 180 to the natural language query 116 that fulfills performance of the task specified by the natural language query 116. The user device 110 may audibly output, from an audio output device (e.g., acoustic speaker) 117, the final answer 180 as synthesized speech. Additionally or alternatively, the user device 110 may display, on a screen 112 in communication with the user device 110, graphics, text, and/or other visual information that conveys the details of the final answer 180.

The system 100 includes the user device 110, a remote computing system 120, and a network 130. The user device 110 includes data processing hardware 113 and memory hardware 114. The user device 110 may include, or be in communication with, an audio capture device 115 (e.g., an array of one or more microphones) for converting utterances of natural language queries 116 spoken by the user 10 into corresponding audio data 102 (e.g., electrical signals or digital data). In lieu of spoken input, the user 10 may input a textual representation of the natural language query 116 via a user interface executing on the user device 110. In scenarios when the user 10 speaks a natural language query captured by the microphone 115 of the user device 110, and automated speech recognition (ASR) system 140 executing on the user device 110 or the remote computing system 120 may process the corresponding audio data 102 to generate a transcription of the query 116. Here, the transcription conveys the natural language query 116 as a textual representation for input to the set of LLM-based assistants 160. The ASR system 140 may implement any number and/or type(s) of past, current, or future speech recognition systems, models and/or methods including, but not limited to, and end-to-end speech recognition model, such as streaming speech recognition models having recurrent neural network-transducer (RNN-T) model architectures, a hidden Markov model, an acoustic model, a pronunciation model, a language model, and/or a naïve Bayes classifier.

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., a cloud computing environment) having scalable elastic resources. The resources include computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

With continued reference to FIG. 1, the task arbitration system 105 includes the ASR system 140 and the set of available LLM-based assistants 160. The ASR system 140 may be optional or only leveraged when the user 10 prefers spoken input of natural language queries 116 as opposed to typed input. In some implementations, the task arbitration system 105 executes on both data processing hardware 113 of the user device 110 and the data processing hardware 123 of the remote computing system 120. For instance, one or more components of the task arbitration system 105 may execute on the data processing hardware 113 of the user device 110 while one or more other components of the task arbitration system 104 may execute on the remote computing system 120. While not shown, LLM based assistants 160 may execute on different remote computing systems depending on the service provider operating the LLM-based assistants 160. As such, the task arbitration system 105 may interact with different LLM-based assistants 160 that execute across a diver set of remote computing systems 120 operated by different providers.

In some implementations, each LLM-based assistant 160 in the set of available LLM based assistants 160 is trained, fine-tuned, and/or conditioned to be experts in a certain domain or carry out particular types of tasks. Thus, each LLM-based assistant 160 may be specialized to perform particular types of tasks for queries 116 based on the training, fine-tuning, and/or conditioning. For instance, conditioning a corresponding LLM-based assistant 160 may include crafting prompts that guide the corresponding LLM-based assistant 160 to optimally perform a particular type of task. Advantageously, by conditioning each LLM-based assistant 160 to be specialized in performing particular types of tasks, the set of LLM-based assistants 160 may achieve specialized and efficient outcomes for various different types of queries 116.

For example, an LLM-based assistant 160 may be specialized (i.e., trained, fine-tuned, conditioned) for generating responses to emails. Here, the task arbitration system 105 may condition the particular LLM-based assistant 160 on a prompt that provides a particular tone, response style, and/or length for generating responses to respond to emails. For instance, the LLM-based assistant 160 may be conditioned on a prompt such as, “draft a polite and professional response to emails” which ensures the LLM-based assistant 160 generates a suitable reply when responding to queries 116 for responding to emails. Additionally or alternatively, the LLM-based assistant 160 may be trained and/or fine-tuned on training data for responding to emails. In another example, an LLM-based assistant 160 may be specialized (i.e., trained, fine-tuned, conditioned) for analyzing invoices. Here, the task arbitration system 105 may condition the particular LLM-based assistant 160 on a prompt that directs the LLM-based assistant 160 to extract key information such as invoice numbers, dates, amounts, and vendor details from invoices. For instance, the LLM-based assistant 160 may be conditioned on a prompt such as, “extract the invoice number, date, total amount, and vendor name from the following invoice text,” guiding the LLM-based assistant 160 to focus on these specific data points when responding to queries regarding invoices. Additionally or alternatively, the LLM-based assistant 160 may be trained and/or fine-tuned on training data for responding to emails. In yet another example, an LLM-based assistant 160 may be specialized (i.e., trained, fine-tuned, conditioned) for responding to various types of inquiries and complaints. Here, the task arbitration system 105 may condition the particular LLM-based assistant 160 on a prompt that directs the LLM-based assistant 160 to use a certain tone, response style, and/or example responses to example inquiries and complaints. For instance, the LLM-based assistant 160 may be conditioned on a prompts such as, “generate a polite response to a customer who is unhappy” and/or “provide troubleshooting steps for a customer experiencing issues with their product” guiding the LLM-based assistant 160 to generate relevant and helpful responses tailed to the needs of customers.

In some implementations, each LLM-based assistant 160 in the set of available LLM-based assistants 160 includes the same underlying LLM. In these implementations, each LLM-based assistant 160 is conditioned to perform a respective type of task that is different than each other LLM-based assistant 160 in the set of available LLM-based assistants 160 despite each LLM-based assistant 160 having the same underlying LLM. In other implementations, each LLM-based assistant 160 in the set of available LLM-based assistants 160 includes a different underlying LLM. For instance, each LLM-based assistant 160 may be fine-tuned and/or specifically trained to perform the respective type of task that is different than each other LLM-based assistant 160 using uniquely tailored training data for the respective type of task.

The task arbitration system 105 executes the arbitration process 200 for selecting an LLM-based assistant 160 from the set of available LLM-based assistants 160 to fulfill performance of the task specified by the query 116. Notably, the arbitration process 200 is performed by the set of LLM-based assistants 160 communicating with one another compared to using a leader LLM-based assistant 160 that selects from multiple LLM-based assistants 160. Simply put, the arbitration process 200 operates in a peer-to-peer manner whereby each of the LLM-based assistants 160 communicate amongst one another without using a leader LLM-based assistant 160 to select one of the LLM-based assistants 160 to respond to the query 116. Each LLM-based assistant 160 in the set of available LLM-based assistants 160 may receive the query 116 whereby execution of the arbitration process 200 for selecting the LLM-based assistant 160 to fulfill performance of the task is initiated by one or more of the LLM-based assistants 160 in the set of available LLM-based assistants 160. Notably, the query 116 received at each LLM-based assistant 160 in the set of available LLM-based assistants is received over a query communication channel 170 that is different than an arbitration communication channel 150 which is used by the arbitration process 200. For instance, the query communication channel 170 may correspond to an email-based communication channel and/or a meeting communication channel which is separate than the arbitration communication channel 150 dedicated to communication regarding selecting the LLM-based assistant 160.

At each corresponding LLM-based assistant 160 in the set of available LLM-based assistants 160, the arbitration process 200 includes processing the query 116 to determine whether the corresponding LLM-based assistant 160 self-identifies as being capable of fulfilling performance of the task specified by the query 116 and to each other LLM-based assistant 160 in the set of available LLM-based assistants 160 a corresponding volunteer bid 162 over the arbitration communication channel 150. The corresponding volunteer bid offers to fulfill performance of the task on-behalf of the other LLM-based assistants 160 in the set of available LLM-based assistants 160. That is, each corresponding LLM-based assistant 160 processes the query 116 to determine the type of task specified by the query 116 and whether the corresponding LLM-based assistant 160 is capable of performing the type of task specified by the query 116. In the example shown, the query 116 specifies a task regarding receiving an invoice in error whereby a first LLM-based assistant 160, 160a and a second LLM-based assistant 160, 160b provide volunteer bids 162 over the arbitration communication channel 150 to offer to perform the task specified by the query 116. More specifically, the first LLM-based assistant 160a provides a first volunteer bid 162, 162a over the arbitration communication channel 150 to the second LLM-based assistant 160b and the second LLM-based assistant 160b provides a second volunteer bid 162, 162b to the first LLM-based assistant 160a over the arbitration communication channel. Moreover, a third LLM-based assistant 160, 160c refrains from providing a volunteer bid 162 since the third LLM-based assistant 160c does not identify as being capable of performing the task specified by the query 116. For instance, the third LLM-based assistant 160c may be conditioned to respond to emails such that the third LLM-based assistant 160c is not capable of performing the invoice related task.

In some examples, the corresponding volunteer bid 162 includes a corresponding justification that provides an explanation for why the corresponding LLM-based assistant self-identifies as being capable of fulfilling performance of the task specified by the query 116. The justification provides the explanation as natural language text. For instance, in the example shown, the first LLM-based assistant 160a may provide the justification of “I can handle this query as I am specialized in financial audits” and the second LLM-based assistant 160b provides the justification of “I can handle this query as I am specialized in accounting tasks.” Notably, both the first and second LLM-based assistants 160a, 160b may self-identify as being capable of performing the task specified by the query 116 whereby the arbitration process 200 determines which one of the LLM-based assistants 160 is most optimized for performing the task.

Thereafter, the arbitration process 200 selects the LLM-based assistant 160 from a subset of LLM-based assistants 160 that include each of the LLM-based assistants 160 in the set of available LLM-based assistants 160 that provided corresponding volunteer bids 162 over the arbitration communication channel 150 to fulfill performance of the task specified by the query 116. In the example shown, the subset of LLM-based assistants 160 includes the first and second LLM-based assistants 160a, 160b (e.g., the LLM-based assistants 160 that provided volunteer bids 162 and are denoted with solid lines) such that the arbitration process selects from the first and second LLM-based assistants 160a, 160b to perform the task specified by the query 116. In some examples, the arbitration process 200 selects the LLM-based assistant 160 to perform the task based on processing (e.g., semantic interpretation) the justification provided by each of the LLM-based assistants 160 that provided volunteer bids 162. Continuing with the example shown, the arbitration process 200 may select the second LLM-based assistant 160b (e.g., denoted with the shaded box) to perform the task based on determining that the justification of “I can handle this query as I am specialized in accounting tasks” provided by the second LLM-based assistant 160b is more relevant to performing the invoice related task specified by the query 116 than the justification of “I can handle this query as I am specialized in financial audits” provided by the first LLM-based assistant 160a.

In some implementations, the arbitration process 200 includes determining which LLM-based assistant 160 in the subset of LLM-based assistants 160 was first to provide the corresponding volunteer bid 162 over the arbitration communication channel 150. Here, selecting the LLM-based assistant 160 to fulfill performance of the task specified by the query 116 includes selecting the LLM-based assistant to fulfill performance of the task as the LLM-based assistant 160 in the subset of LLM-based assistants 160 that was first to provide the corresponding volunteer bid 162 over the arbitration communication channel 150. For instance, each corresponding volunteer bid 162 may include a respective timestamp indicating when the corresponding LLM-based assistant 160 generated the corresponding volunteer bid 162 such that the arbitration process 200 may discern which LLM-based assistant was the first to provide the corresponding volunteer bid 162 over the arbitration communication channel 150.

The selected LLM-based assistant 160 solicits each corresponding other LLM-based assistant 160 in the subset of the LLM-based assistants 160 that was not selected to fulfill performance of the task to provide a respective collaboration input 164 indicating how the corresponding other LLM-based assistant 160 would respond to the query 116 over the arbitration communication channel 150. That is, each LLM-based assistant 160 that provided a respective volunteer bid 162 but was not selected by the arbitration process 200 to perform the task specified by the query 116 processes the query 116 to generate a respective collaboration input 164 and send the respective collaboration input 164 to the selected LLM-based assistant 160. The collaboration input 164 may include the answer that the corresponding other LLM-based assistant 160 would generate if the corresponding LLM-based assistant 160 was selected to perform the task specified by the query 116. As such, even though the other LLM-based assistants 160 in the subset of LLM-based assistants 160 that were not selected by the arbitration process, the other LLM-based assistants 160 may still process the query 116 to generate an answer to the query 116 and provide the answer as the respective collaboration input 164 to the selected LLM-based assistant 160. Continuing with the example shown, the first LLM-based assistant 160a provides a first collaboration input 164, 164a to the second LLM-based assistant 160b.

The selected LLM-based assistant 160 generates the final answer 180 to the query 116 that fulfills performance of the task specified by the query 116 based on the respective collaboration input 164 provided by each corresponding other LLM-based assistant 160 in the subset of LLM-based assistants 160. That is, the selected LLM-based assistant 160 is conditioned on the respective collaboration input 164 provided by each corresponding other LLM-based assistant 160 in the subset of LLM-based assistants 160 and processes the query 116 to generate the final answer 180 to the query 116. Advantageously, the selected LLM-based assistant 160 processes the query 116 to generate the final answer 180 with the benefit of the additional context provided by the other LLM-based assistants 160. Put another way, the selected LLM-based assistant 160 generates the final answer 180 while the selected LLM-based assistant 160 is conditioned on the respective collaboration input 164 provided by each other corresponding LLM-based assistant 160 that provided a corresponding volunteer bid 162 but was not selected to perform the task.

In some implementations, the collaboration input 164 includes a contextual cue indicating guidance for the selected LLM-based assistant 160 to consider when generating the final answer 180 to the query 116. That is, in addition to, or in lieu of, indicating how the corresponding other LLM-based assistant 160 would respond to the query 116, the corresponding other LLM-based assistant 160 may generate the contextual cue indicating context for the selected LLM-based assistant 160 to consider when generating the final answer 180. For instance, the first LLM-based assistant 160a may generate the contextual cue of “please consider the amount indicated on the invoice when generating the answer.” As such, the contextual cue provided by the first LLM-based assistant 160a to the second LLM-based assistant 160b causes the second LLM-based assistant 160b to consider the amount indicated on the invoice (if any) when generating the final answer 180 to the query 116. The selected LLM-based assistant 160 processes the query 116 and the respective collaboration inputs 164 provided by other LLM-based assistants 160 to generate the final answer 180 to the query 116. In the example shown, the arbitration process 200 selects the second LLM-based assistant 160b which processes the query 116 and the first collaboration input 164 from the first LLM-based assistant 160a to generate the final answer 180 of “yes it appears that this invoice was received in error.” Notably, the solicitation by the selected LLM-based assistant 160 and the generation of the final answer 180 may be part of the arbitration process 200 or independent from the arbitration process 200.

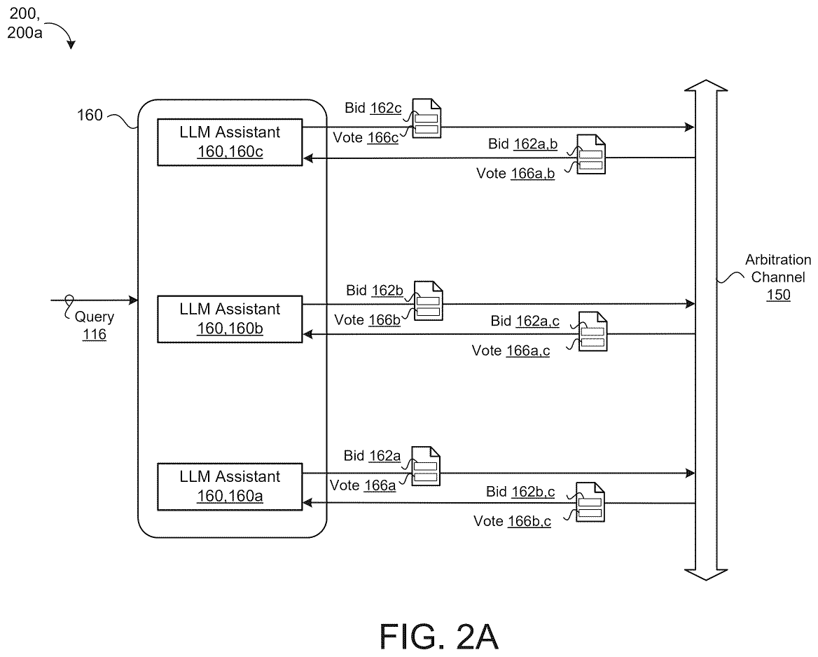

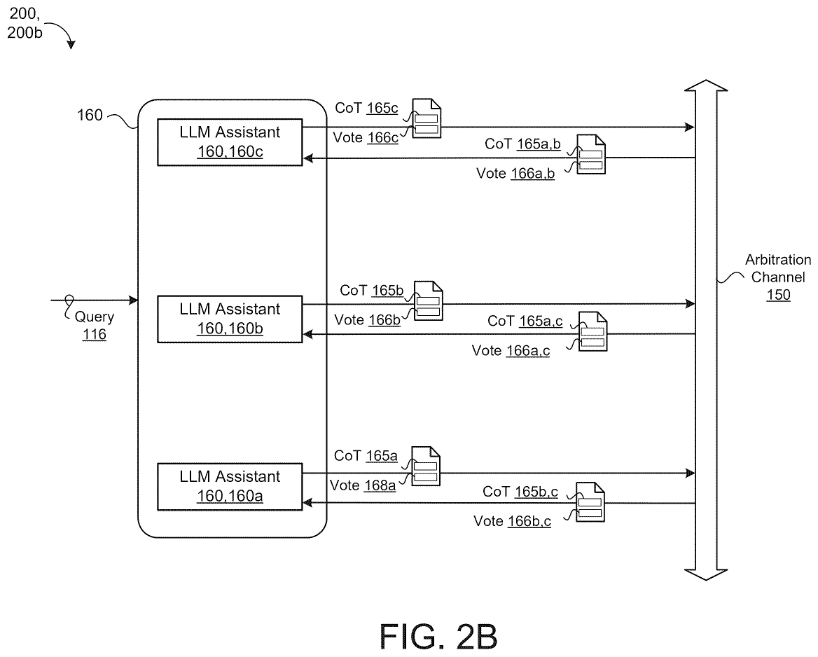

FIGS. 2A and 2B illustrate an example arbitration process 200 whereby the LLM-based assistants 160 in the subset of LLM-based assistants 160 provide corresponding votes 166 to select the LLM-based assistant 160 to fulfill performance of the task specified by the query 116. In the example shown, there are four LLM-based assistants 160 in the subset of LLM-based assistants 160 and all other LLM-based assistants 160 that did not provide a corresponding volunteer bid 162 are omitted for the sake of clarity only. In the example shown, there are three LLM-based assistants 160a-c in the subset of LLM-based assistants 160.

Referring now specifically to FIG. 2A, a first example arbitration process 200, 200a includes, at each corresponding LLM-based assistant 160 in the subset of LLM-based assistants, processing the corresponding volunteer bids 162 and the corresponding justifications provided by the other LLM-based assistants 160 in the subset of LLM-based assistants 160 to identify a best LLM-based assistant 160 in the subset of LLM-based assistants 160 to fulfill performance of the task. Based on processing the corresponding volunteer bids 162 and the corresponding justifications received from other LLM-based assistants 160 in the subset of LLM-based assistants 160, each corresponding LLM-based assistant 160 provides a corresponding vote 166 to select the LLM-based assistant 160 that the corresponding LLM-based assistant 160 identified as the best LLM-based assistant 160 to fulfill performance of the task. For instance, in the example shown, the first LLM-based assistant 160a receives corresponding volunteer bids 162b, 162c and corresponding justifications from the second LLM-based assistant 160b and the third LLM-based assistant 160c and generates a corresponding first vote 166, 166a that is sent to the other LLM-based assistants 160 over the arbitration communication channel 150. Similarly, the second LLM-based assistant 160b receives corresponding volunteer bids 162a, 162c and corresponding justifications from the first LLM-based assistant 160a and the third LLM-based assistant 160c and generates a corresponding second vote 166, 166b that is sent to the other LLM-based assistants 160 over the arbitration communication channel 150. Moreover, the third LLM-based assistant 160c receives corresponding volunteer bids 162a, 162b and corresponding justifications from the first LLM-based assistant 160a and the second LLM-based assistant 160b and generates a corresponding third vote 166, 166c that is sent to the other LLM-based assistants 160 over the arbitration communication channel 150.

Thereafter, the arbitration process 200 selects a candidate LLM-based assistant 160 to fulfill performance of the task specified by the query 116 as the LLM-based assistant 160 from the subset of LLM-based assistants 160 based on the corresponding votes 166 provided over the arbitration communication channel 150. In some examples the arbitration process 200 selects the candidate LLM-based assistant 160 based on which LLM-based assistant 160 received the greatest number of votes 166. In some scenarios, one or more of the LLM-based assistants 160 may receive a same number of votes 166 such that the arbitration process 200 cannot pick a single LLM-based assistant 160 to perform the task.

FIG. 2B illustrates a second example arbitration process 200, 200b with a rebuttal round. In some examples, the arbitration process 200 may include multiple rebuttal rounds. Each rebuttal round is configured to break one or more voting ties between LLM-based assistants 160 such that the arbitration process 200 may narrow down to a single LLM-based assistant 160 with the greatest number of votes 166. At each corresponding LLM-based assistant 160 in the subset of LLM-based assistants 160, each rebuttal round includes providing a corresponding chain-of-thought (CoT) reasoning 165 for why the corresponding LLM-based assistant 160 provided the corresponding vote 166 to select the LLM-based assistant 160 that the corresponding LLM-based assistant identified as the best LLM-based assistant 160 to fulfill performance of the task. Thereafter, each corresponding LLM-based assistant 160 in the subset of LLM-based assistants 160 processes the corresponding CoT reasonings 165 provided from the other LLM-based assistants 160 in the subset of LLM-based assistants 160 to determine whether the corresponding LLM-based assistant 160 should update the corresponding vote to select a different one of the LLM-based assistants 160 to fulfill performance of the task. When the corresponding LLM-based assistant 160 determines to update the corresponding vote 162 to select the different one of the LLM-based assistants 160, the corresponding LLM-based assistant 160 provides a corresponding updated vote 168 to select the different one of the LLM-based assistants 160 that the corresponding LLM-based assistant 160 identified as the best LLM-based assistant 160 to fulfill performance of the task. After execution of the one or more rebuttal rounds is complete, the arbitration process 200 includes determining which LLM-based assistant 160 in the subset of LLM-based assistants 160 includes a greatest number of votes 166, 168 to fulfill performance of the task. The greatest number of votes 166, 168 may be determined based on the corresponding initial votes 166 and/or the updated votes 168.

In the example shown, the first LLM-based assistant 160a provides a corresponding first CoT reasoning 165, 165a for why the first LLM-based assistant 160a voted for the best LLM-based assistant 160 that it voted for, the second LLM-based assistant 160b provides a corresponding second CoT reasoning 165, 165b for why the second LLM-based assistant 160b voted for the best LLM-based assistant 160 it voted for, and the third LLM-based assistant 160c provides a corresponding third CoT reasoning 165, 165c for why the third LLM-based assistant 160c voted for the best LLM-based assistant 160 it voted for. Thereafter, each LLM-based assistant 160 processes the corresponding CoT reasonings 165 to determine whether to update the corresponding vote 166 previously provided or not. In this example, the first LLM-based assistant 160a determines to update its vote 166 based on processing the second and third CoT reasonings 165b, 165c and provides a corresponding first updated vote 168, 168 to the other LLM-based assistants 160 over the arbitration communication channel 150. Continuing with this example, the second and third assistant-based LLMs 160b, 160c determine not to update their vote 166 based on the received CoT reasonings 165. As such, the arbitration process 200 may select the LLM-based assistant 160 to perform the task based on the corresponding first updated vote 168a and the corresponding second and third votes 166b, 166c.

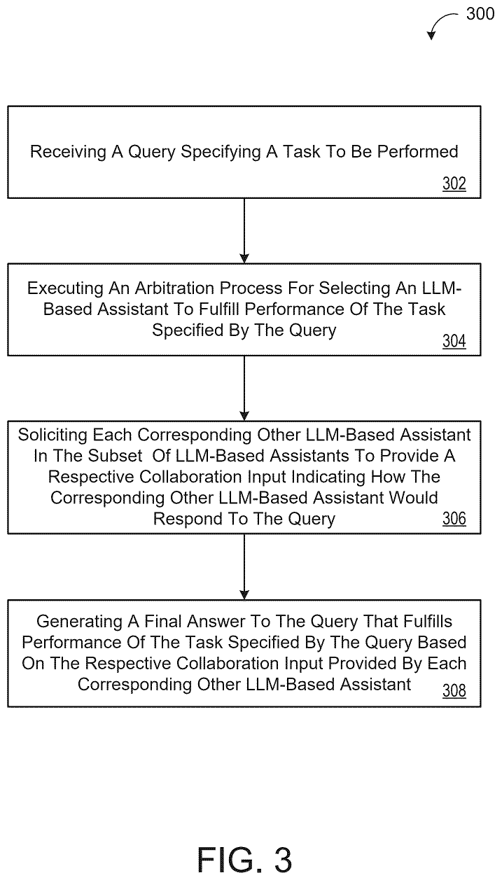

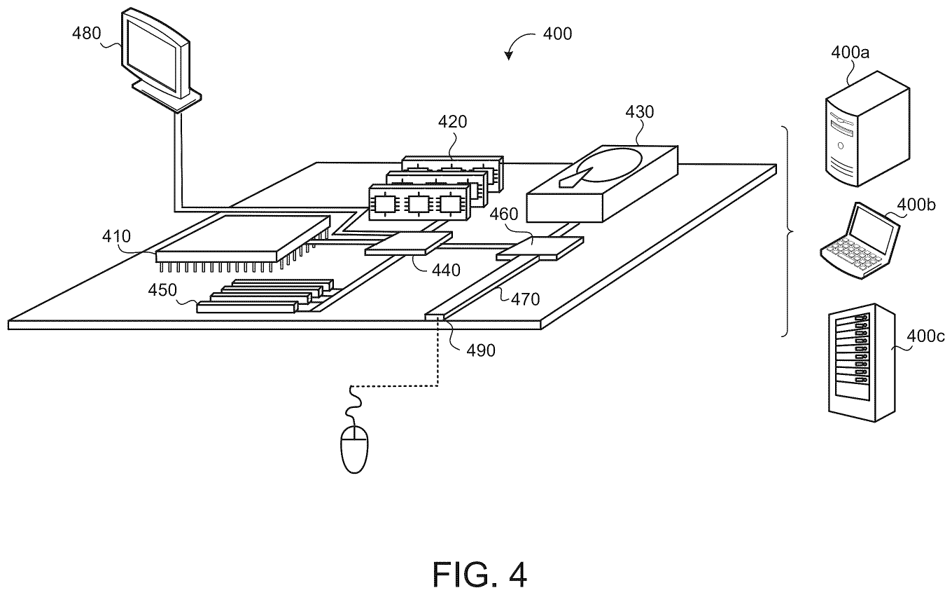

FIG. 3 illustrates a flowchart of an example flowchart of operations for a computer-implemented method 300 of performing task arbitration. The method 300 may execute on data processing hardware 410 (FIG. 4) using instructions stored on memory hardware 420 (FIG. 4) that may reside on the user device 110 and/or the remote computing system 120 of FIG. 1 each corresponding to a computing device 400 (FIG. 4).

At operation 302, the method 300 includes receiving a query 116 specifying a task to be performed. At operation 304, the method 300 includes executing an arbitration process 200 for selecting an LLM-based assistant 160 from a set of available LLM-based assistants 160 to fulfill performance of the task specified by the query 116. The arbitration process 200 includes, at each corresponding LLM-based assistant 160 in the set of available LLM-based assistants 160, processing the query 116 to determine whether the corresponding LLM-based assistant 160 self-identifies as being capable of fulfilling performance of the task specified by the query 116 and providing a corresponding volunteer bid 162 from the corresponding LLM-based assistant 160 that offers to fulfill performance of the task on-behalf of the other LLM-based assistants 160 in the set of available LLM-based assistants 160 over an arbitration communication channel 150 to each other LLM-based assistant 160 in the set of available LLM-based assistants 160 when the corresponding LLM-based assistant 160 self-identifies as being capable of fulfilling performance of the task. The arbitration process 200 also includes selecting the LLM-based assistant 160 from a subset of LLM-based assistants 160 that include each of the LLM-based assistants 160 in the set of available LLM-based assistants 160 that provided corresponding volunteer bids 162 over the arbitration communication channel 150 to fulfill performance of the task specified by the query 116. At operation 306, the method 300 includes soliciting, by the selected LLM-based assistant 160, each corresponding other LLM-based assistant 160 in the subset of the LLM-based assistants 160 that was not selected to fulfill performance of the task to provide a respective collaboration input 164 indicating how the corresponding other LLM-based assistant 160 would respond to the query 116 over the arbitration communication channel 150. At operation 308, the method 300 includes generating, by the selected LLM-based assistant 160, a final answer 180 to the query 116 that fulfills performance of the task specified by the query 116 based on the respective collaboration input 164 provided by each corresponding other LLM-based assistant 160 in the subset of LLM-based assistants 160.

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware that causes the data processing hardware to perform operations comprising:
receiving a query specifying a task to be performed;
executing an arbitration process for selecting, from a set of available large language model (LLM)-based assistants, an LLM-based assistant to fulfill performance of the task specified by the query, wherein the arbitration process comprises;
at each corresponding LLM-based assistant in the set of available LLM-based assistants:
processing the query to determine whether the corresponding LLM-based assistant self-identifies as being capable of fulfilling performance of the task specified by the query; and
when the corresponding LLM-based assistant self-identifies as being capable of fulfilling performance of the task, providing, over an arbitration communication channel, to each other LLM-based assistant in the set of available LLM-based assistants, a corresponding volunteer bid from the corresponding LLM-based assistant that offers to fulfill performance of the task on-behalf of the other LLM-based assistants in the set of available LLM-based assistants; and
selecting, from a subset of LLM-based assistants that include each of the LLM-based assistants in the set of available LLM-based assistants that provided corresponding volunteer bids over the arbitration communication channel, the LLM-based assistant to fulfill performance of the task specified by the query;
soliciting, by the selected LLM-based assistant, each corresponding other LLM-based assistant in the subset of the LLM-based assistants that was not selected to fulfill performance of the task to provide, over the arbitration communication channel, a respective collaboration input indicating how the corresponding other LLM-based assistant would respond to the query; and
based on the respective collaboration input provided by each corresponding other LLM-based assistant in the subset of LLM-based assistants, generating, by the selected LLM-based assistant, a final answer to the query that fulfills performance of the task specified by the query.

2. The method of claim 1, wherein:
receiving the query comprises receiving the query at each LLM-based assistant in the set of available LLM-based assistants; and
execution of the arbitration process for selecting the LLM-based assistant to fulfill performance of the task is initiated by one or more of the LLM-based assistants in the set of available LLM-based assistants.

3. The method of claim 2, wherein the query received at each LLM-based assistant in the set of available LLM-based assistants is received over a query communication channel that is different than the arbitration communication channel.

4. The method of claim 1, wherein providing the corresponding volunteer bid from the corresponding LLM-based assistant further comprises providing, over the arbitration communication channel, to each other LLM-based assistant in the set of available LLM-based assistants, a corresponding justification that provides an explanation for why the corresponding LLM-based assistant self-identifies as being capable of fulfilling performance of the task specified by the query.

5. The method of claim 4, wherein selecting the LLM-based assistant to fulfill performance of the task specified by the query comprises:
at each corresponding LLM-based assistant in the subset of LLM-based assistants:
processing the corresponding volunteer bids and the corresponding justifications provided by the other LLM-based assistants in the subset of LLM-based assistants to identify a best LLM-based assistant in the subset of LLM-based assistants to fulfill performance of the task; and
providing, over the arbitration communication channel, to each other LLM-based assistant in the subset of LLM-based assistants, a corresponding vote to select the LLM-based assistant that the corresponding LLM-based assistant identified as the best LLM-based assistant to fulfill performance of the task; and
selecting, from the subset of LLM-based assistants, a candidate LLM-based assistant to fulfill performance of the task specified by the query as the LLM-based assistant from the subset of LLM-based assistant based on the corresponding votes provided over the arbitration communication channel.

6. The method of claim 5, wherein the operations further comprise, after selecting the candidate LLM-based assistant to fulfill performance of the task:
executing one or more rebuttal rounds of the arbitration process, each rebuttal round comprising, at each corresponding LLM-based assistant in the subset of LLM-based assistants:
providing, over the arbitration communication channel, to each other LLM-based assistant in the subset of LLM-based assistants, a corresponding chain-of-thought (CoT) reasoning for why the corresponding LLM-based assistant provided the corresponding vote to select the LLM-based assistant that the corresponding LLM-based assistant identified as the best LLM-based assistant to fulfill performance of the task;
processing the corresponding CoT reasonings provided from the other LLM-based assistants in the subset of LLM-based assistants to determine whether the corresponding LLM-based assistant should update the corresponding vote to select a different one of the LLM-based assistants to fulfill performance of the task; and
when the corresponding LLM-based assistant determines to update the corresponding vote to select the different one of the LLM-based assistants, providing, over the arbitration communication channel, to each other LLM-based assistant in the subset of LLM-based assistants, a corresponding updated vote to select the different one of the LLM-based assistants that the corresponding LLM-based assistant identified as the best LLM-based assistant to fulfill performance of the task; and
after execution of the one or more rebuttal rounds is complete, determining which LLM-based assistant in the subset of LLM-based assistants includes a greatest number of votes to fulfill performance of the task,
wherein selecting the LLM-based assistant to fulfill performance of the task specified by the query comprises selecting, from the subset of LLM-based assistants, the LLM-based assistant determined to include the greatest number of votes to fulfill performance of the task.

7. The method of claim 4, wherein the corresponding justification provides the explanation as natural language text.

8. The method of claim 1, wherein the arbitration process further comprises:
determining which LLM-based assistant in the subset of LLM-based assistants was first to provide the corresponding volunteer bid over the arbitration communication channel,
wherein selecting the LLM-based assistant to fulfill performance of the task specified by the query comprises selecting the LLM-based assistant to fulfill performance of the task as the LLM-based assistant in the subset of LLM-based assistants that was first to provide the corresponding volunteer bid over the arbitration communication channel.

9. The method of claim 1, wherein the operations further comprise:
soliciting, by the selected LLM-based assistant, each corresponding other LLM-based assistant in the subset of the LLM-based assistants that was not selected to fulfill performance of the task to provide, over the arbitration communication channel, a respective contextual cue indicating guidance for the selected LLM-based assistant to consider when generating the final answer to the query,
wherein generating the final answer to the query is further based on the respective contextual cue provided by each corresponding other LLM-based assistant in the subset of LLM-based assistants.

10. The method of claim 1, wherein each corresponding LLM-based assistant in the set of available LLM-based assistants is conditioned to perform a respective type of task that is different than each other LLM-based assistant in the set of available LLM-based assistants.

11. A system comprising:
data processing hardware; and
memory hardware in communication with the data processing hardware, the memory hardware storing instructions that when executed on the data processing hardware cause the data processing hardware to perform operations comprising:
receiving a query specifying a task to be performed;
executing an arbitration process for selecting, from a set of available large language model (LLM)-based assistants, an LLM-based assistant to fulfill performance of the task specified by the query, wherein the arbitration process comprises:
at each corresponding LLM-based assistant in the set of available LLM-based assistants:
processing the query to determine whether the corresponding LLM-based assistant self-identifies as being capable of fulfilling performance of the task specified by the query; and
when the corresponding LLM-based assistant self-identifies as being capable of fulfilling performance of the task, providing, over an arbitration communication channel, to each other LLM-based assistant in the set of available LLM-based assistants, a corresponding volunteer bid from the corresponding LLM-based assistant that offers to fulfill performance of the task on-behalf of the other LLM-based assistants in the set of available LLM-based assistants; and
selecting, from a subset of LLM-based assistants that include each of the LLM-based assistants in the set of available LLM-based assistants that provided corresponding volunteer bids over the arbitration communication channel, the LLM-based assistant to fulfill performance of the task specified by the query;
soliciting, by the selected LLM-based assistant, each corresponding other LLM-based assistant in the subset of the LLM-based assistants that was not selected to fulfill performance of the task to provide, over the arbitration communication channel, a respective collaboration input indicating how the corresponding other LLM-based assistant would respond to the query; and
based on the respective collaboration input provided by each corresponding other LLM-based assistant in the subset of LLM-based assistants, generating, by the selected LLM-based assistant, a final answer to the query that fulfills performance of the task specified by the query.

12. The system of claim 11, wherein:
receiving the query comprises receiving the query at each LLM-based assistant in the set of available LLM-based assistants; and
execution of the arbitration process for selecting the LLM-based assistant to fulfill performance of the task is initiated by one or more of the LLM-based assistants in the set of available LLM-based assistants.

13. The system of claim 12, wherein the query received at each LLM-based assistant in the set of available LLM-based assistants is received over a query communication channel that is different than the arbitration communication channel.

14. The system of claim 11, wherein providing the corresponding volunteer bid from the corresponding LLM-based assistant further comprises providing, over the arbitration communication channel, to each other LLM-based assistant in the set of available LLM-based assistants, a corresponding justification that provides an explanation for why the corresponding LLM-based assistant self-identifies as being capable of fulfilling performance of the task specified by the query.

15. The system of claim 14, wherein selecting the LLM-based assistant to fulfill performance of the task specified by the query comprises:
at each corresponding LLM-based assistant in the subset of LLM-based assistants:
processing the corresponding volunteer bids and the corresponding justifications provided by the other LLM-based assistants in the subset of LLM-based assistants to identify a best LLM-based assistant in the subset of LLM-based assistants to fulfill performance of the task; and
providing, over the arbitration communication channel, to each other LLM-based assistant in the subset of LLM-based assistants, a corresponding vote to select the LLM-based assistant that the corresponding LLM-based assistant identified as the best LLM-based assistant to fulfill performance of the task; and
selecting, from the subset of LLM-based assistants, a candidate LLM-based assistant to fulfill performance of the task specified by the query as the LLM-based assistant from the subset of LLM-based assistant based on the corresponding votes provided over the arbitration communication channel.

16. The system of claim 15, wherein the operations further comprise, after selecting the candidate LLM-based assistant to fulfill performance of the task:
executing one or more rebuttal rounds of the arbitration process, each rebuttal round comprising, at each corresponding LLM-based assistant in the subset of LLM-based assistants:
providing, over the arbitration communication channel, to each other LLM-based assistant in the subset of LLM-based assistants, a corresponding chain-of-thought (CoT) reasoning for why the corresponding LLM-based assistant provided the corresponding vote to select the LLM-based assistant that the corresponding LLM-based assistant identified as the best LLM-based assistant to fulfill performance of the task;
processing the corresponding CoT reasonings provided from the other LLM-based assistants in the subset of LLM-based assistants to determine whether the corresponding LLM-based assistant should update the corresponding vote to select a different one of the LLM-based assistants to fulfill performance of the task; and
when the corresponding LLM-based assistant determines to update the corresponding vote to select the different one of the LLM-based assistants, providing, over the arbitration communication channel, to each other LLM-based assistant in the subset of LLM-based assistants, a corresponding updated vote to select the different one of the LLM-based assistants that the corresponding LLM-based assistant identified as the best LLM-based assistant to fulfill performance of the task; and
after execution of the one or more rebuttal rounds is complete, determining which LLM-based assistant in the subset of LLM-based assistants includes a greatest number of votes to fulfill performance of the task,
wherein selecting the LLM-based assistant to fulfill performance of the task specified by the query comprises selecting, from the subset of LLM-based assistants, the LLM-based assistant determined to include the greatest number of votes to fulfill performance of the task.

17. The system of claim 14, wherein the corresponding justification provides the explanation as natural language text.

18. The system of claim 11, wherein the arbitration process further comprises:
determining which LLM-based assistant in the subset of LLM-based assistants was first to provide the corresponding volunteer bid over the arbitration communication channel,
wherein selecting the LLM-based assistant to fulfill performance of the task specified by the query comprises selecting the LLM-based assistant to fulfill performance of the task as the LLM-based assistant in the subset of LLM-based assistants that was first to provide the corresponding volunteer bid over the arbitration communication channel.

19. The system of claim 11, wherein the operations further comprise:
soliciting, by the selected LLM-based assistant, each corresponding other LLM-based assistant in the subset of the LLM-based assistants that was not selected to fulfill performance of the task to provide, over the arbitration communication channel, a respective contextual cue indicating guidance for the selected LLM-based assistant to consider when generating the final answer to the query,
wherein generating the final answer to the query is further based on the respective contextual cue provided by each corresponding other LLM-based assistant in the subset of LLM-based assistants.

20. The system of claim 11, wherein each corresponding LLM-based assistant in the set of available LLM-based assistants is conditioned to perform a respective type of task that is different than each other LLM-based assistant in the set of available LLM-based assistants.
